(19) United States
(12) Patent Application Publication
(10) Pub. No.: US 2008/0018912 A1
(43) Pub. Date: Jan. 24, 2008

(54) Position Finding System For Locating The Position Of A Tool

(76) Inventor: Alfred Schreiber, Kirchheim (DE)

Correspondence Address: ST. ONGE STEWARD JOHNSTON & REENS, LLC, 986 BEDFORD STREET, STAMFORD, CT, 06905-5619, US

(21) Appl. No.: 11/777,545

(22) Filed: Jul. 13, 2007

(30) Foreign Application Priority Data
Jul. 18, 2006 (DE) 10 2006 034 270.4

(51) Int. Cl. G01B 11/14; G01B 17/00

(52) U.S. Cl. 356/623

(57) ABSTRACT

The invention provides a position finding system and a method for locating the position of a tool, in particular a hand-held screwdriver, wherein free-field position finding is performed for determining the absolute position of the tool and wherein relative position finding is performed for determining the relative position of the tool by tracking the movement of the tool relative to a known reference position, and combining the results with the result of the free-field position finding process for determining the position of the tool.

### CROSS-REFERENCE TO RELATED APPLICATIONS

The present application claims priority of German patent application No. 10 2006 034 270.4 filed on a Jul. 18, 2006, the content of which is incorporated herein by reference.

### FIELD OF THE INVENTION

The present invention relates to a position finding method and system for locating a tool, in particular a power screwdriver, more particularly a hand-held power screwdriver.

### BACKGROUND OF THE INVENTION

Different methods for sensing the position of tools are known in the prior art.

DE 199 01 334 A1 discloses a system for sensing the position of a hand-held tool comprising a computer and a sensor system, where the sensor system is located in or on or near the tool, where variations in the position of the tool are sensed by the sensor system, and where the locations of one or more possible working positions on an object to be worked are known and the position determined by a computer is compared with the possible working position findings of a known object.

The sensor system uses inertial sensors whose variation from a known reference point is detected and determined using the computer.

A position-sensing system using inertial sensors is known also from DE 103 12 154 A1 and DE 10 2004 046 000 A1. If the original position is known, movements of objects can be monitored in this way with the aid of inertial sensors.

However, the inertial systems commonly used have only small working spaces due to constructional drift. This means that any position finding performed over longer periods of times (more than 5 seconds) and longer distances (more than 50 centimeters) will lack the necessary accuracy.

In addition, it is basically known in the prior art to determine an absolute position of an object by free-field position finding. This can be accomplished, for example, by ultrasound measurement, propagation time measurement, by means of optical systems with respect to known reference points or by a GPS system.

However, as a rule such free-field position finding systems require a direct connection to be capable of determining the position by propagation time measurements, or by triangulation, for example.

When tightening screws in an assembly line for vehicles, defective screw connections have been encountered again and again because the exact coordination between screwdriver and bodyshell is not sufficiently verified.

As has been explained before, the use of inertial systems for relative position finding purposes does not provide sufficient accuracy over longer distances or times. On the other hand, free-field position finding systems can no longer be used for absolute determination of a position in cases where no direct connection to the outside, for determination of the position, can be ensured due to line-of-sight obstructions existing in the component.

### SUMMARY OF THE INVENTION

It is a first object of the present invention to disclose an improved position finding method for locating the position of a tool.

It is a second object of the present invention to disclose an improved position finding system for locating the position of a tool.

It is a third object of the present invention to disclose an improved system and method for locating the position of a tool by which safe and sufficiently exact position finding of a tool is rendered possible, even under conditions when line-of-sight view to base stations is obstructed.

According to the invention these and other objects are achieved by a position finding system for locating the position of a tool, in particular a hand-held screwdriver intended for working a workpiece, comprising a first free-field position finding system for absolute determination of a position of a tool and a second relative position finding system for relative determination of the position by tracking the movement of the tool relative to a known reference position, the first system and the second system being coupled one with the other for locating the tool.

The object of the invention is further achieved by a method for locating a tool, in particular a hand-held screwdriver, wherein free-field position finding is performed for determining the absolute position of the tool and relative position finding is performed for determining the relative position of the tool by tracking the movement of the tool relative to a known reference position, and combining the results with the result of the free-field position finding process to determine the position of the tool.

The object of the invention is perfectly achieved in this way.

By combining free-field position finding of a tool with relative position finding for relative determination of a position by tracking the movement of a tool relative to a known reference position it is possible to make use of the advantages of both position finding systems. Every time free-field position finding is rendered impossible by a line-of-sight obstruction encountered by the tool the final position can be determined by relative position finding, based on a known original position that has been determined before by free-field position finding. Accordingly, when screwing bodyshells, for example, it can be ensured in this way that the tool will be positioned at all screw positions one after the other. Namely, using the relative position finding system it is possible to work with high precision and independently of a position control system, even in shaded or hidden spaces, for processing a sequence of screwing positions.

Further, the use of the free-field position finding system guarantees stable position finding results over long periods of time. The tool can be safely positioned at the workpiece, for example a bodyshell in an assembly line, in this way. This can be accomplished, for example, by positioning the tool initially at a reference position whereafter the screwing operations are performed on the workpiece using the relative position finding system, starting from that reference position.

According to an advantageous further development of the invention, the position of the tool, having been determined by free-field position finding, is supplied to the second system as a reference position for relative position finding.

It is thus possible, starting from a position that has been accurately determined by free-field position finding, to achieve correspondingly accurate relative position finding over short distances.

According to another embodiment of the invention, a plurality of base stations, preferably at least three base stations, are provided that are coupled with the tool via direct signal paths for free-field position finding.

In that case, the system may for example evaluate ultrasound signals, propagation time measurements and/or GPS signals or optical signals for free-field position finding.

Using three base stations it is possible, in the presence of direct signal paths, to perform free-field position finding in a three-dimensional space. If a connection exists to two base stations only, free-field position finding can be performed in the two-dimensional space.

The tool preferably is coupled with the base stations via signals the propagation time of which is evaluated for deriving the absolute position in space of the tool.

According to another embodiment of the invention, information on the absolute position that has been determined by free-field position finding is supplied to the second system and is used for intermediate balancing with the relative position determined by the relative position finding system.

It is possible in this way to determine and correct any errors that may be encountered in the relative position finding process due to drift occurring on constructional grounds or due to longer distances.

According to still another embodiment of the invention, the position finding system comprises a plurality of tools that are coupled with a plurality of base stations for free-field position finding by direct communication with the base stations, some of the tools being designed as relay stations for establishing connection to other tools that are in direct contact with those tools and with the different base stations.

In cases where a tool, while having direct contact with two base stations, is shaded relative to the third base station, it is possible in this way to transmit the information required for absolute position determination via another tool that is in direct contact with the respective base station.

The second relative position finding system preferably is an inertia-based system that preferably comprises inertial sensors and angle rate sensors.

It is possible in this way to achieve highly exact position finding results using known algorithms.

According to another embodiment of the invention, each tool comprises a radio module that is designed for data communication and that communicates with a plurality of base stations in order to permit absolute position determination, based on propagation time information, where each tool further comprises an inertial module for relative position finding purposes.

An advantageous further development of the method according to the invention further uses the position determined by free-field position finding as a reference position for relative position finding purposes.

This permits the position determination accuracy to be further improved provided that, starting out from the reference position determined by free-field position finding, only short distances have to be sensed using the relative position finding system.

According to another embodiment of the method according to the invention, a position of the tool determined by free-field position finding is taken as an intermediate reference point and is compared with the tool position determined by relative position finding.

This permits errors in the relative position finding to be detected and corrected, and the overall accuracy of the relative position finding system to be clearly improved.

As has been mentioned before, the free-field locating method preferably comprises evaluation of ultrasound signals, of local time measurements and/or of GPS signals or optical signals, and the tool may be coupled in particular with a plurality of base stations, the propagation time of which is evaluated to determine an absolute position of the tool in space.

It is understood that the features of the invention mentioned above and those yet to be explained below can be used not only in the respective combination indicated, but also in other combinations, without leaving the scope of the invention.

### BRIEF DESCRIPTION OF THE DRAWINGS

Further features and advantages of the invention will become apparent from the description that follows of preferred embodiments of the invention, with reference to the drawing. In the drawings show:

FIG. 1 a diagrammatic representation of a tool according to the invention that comprises a combined system for free-field position finding and relative position finding and that is coupled with three base stations via direct communication links;

FIG. 2 a greatly simplified block diagram of an inertial system for relative position finding of the tool according to FIG. 1; and

FIG. 3 a diagrammatic representation of a position finding system according to the invention with three tools and three base stations, one tool being located in a workpiece that obstructs the line of view.

### DETAILED DESCRIPTION OF THE INVENTION

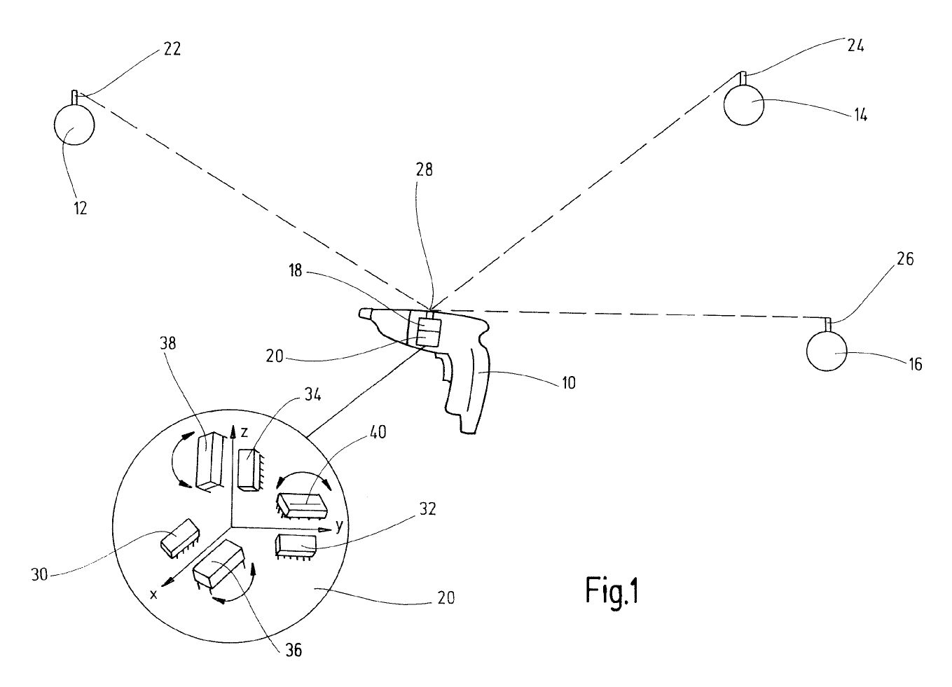

FIG. 1 shows a diagrammatic representation of a position finding system according to the invention which comprises a tool 10 in the form of a power screwdriver that is in direct communication contact with three base stations 12, 14, 16. The tool 10 comprises a radio module 18 and an inertial module 20 that are coupled one with the other. The radio module 18 is directly linked, via an antenna 28, with antennas 22, 24, 26 of external base modules 12, 14,16 the position of which is known.

The radio module 18 thus can determine the absolute position of the antenna 28 by propagation time measurements.

If positionally exact determination of the position of the tool 10 should be necessary, at least three antennas are required that should by in direct radio communication with the base stations in order to determine three points of the tool in space and, thus, the absolute position of the tool 10 in space.

For most of the applications it will, however, be sufficient to determine the position of a single point of the tool 10 only.

A different approach for determining the absolute position of the tool using triangulation with respect to several reference points is also possible.

The tool 10 further comprises an inertial module indicated generally by reference numeral 20, which comprises three acceleration sensors 30, 32, 34 capable of measuring accelerations in the x direction, y direction and z direction, and further the three angle rate sensors 36, 38, 40 for determining the rotary movements about the x axis, the y axis and the z axis. Using a timing module, the position of the tool 10 can be determined based on the signals of the acceleration sensors 30, 32, 34 by simple integration over time, provided the position of the tool 10 at the time P=0 is defined as the original or reference point. A second integration over time even makes it possible to determine the trajectory of the system, i.e. the path of the system that is followed by the tool to in space, i.e. relative to its environment. The timing module is needed for integration and time recording purposes.

Further, there may be provided three angle rate sensors 36, 38, 40 that supply information signals corresponding to the angular speeds. The sense of rotation can be determined from the sign of the angular speed. Using the angle rate sensors the orientation of the tool 10 can be determined.

DE 103 12 154 A1 describes a method wherein an orientation is determined by three angle rate sensors only. According to that method, no additional sensors are needed for determining the orientation of an object in space. Such a method can be used for determining the orientation of the tool 10.

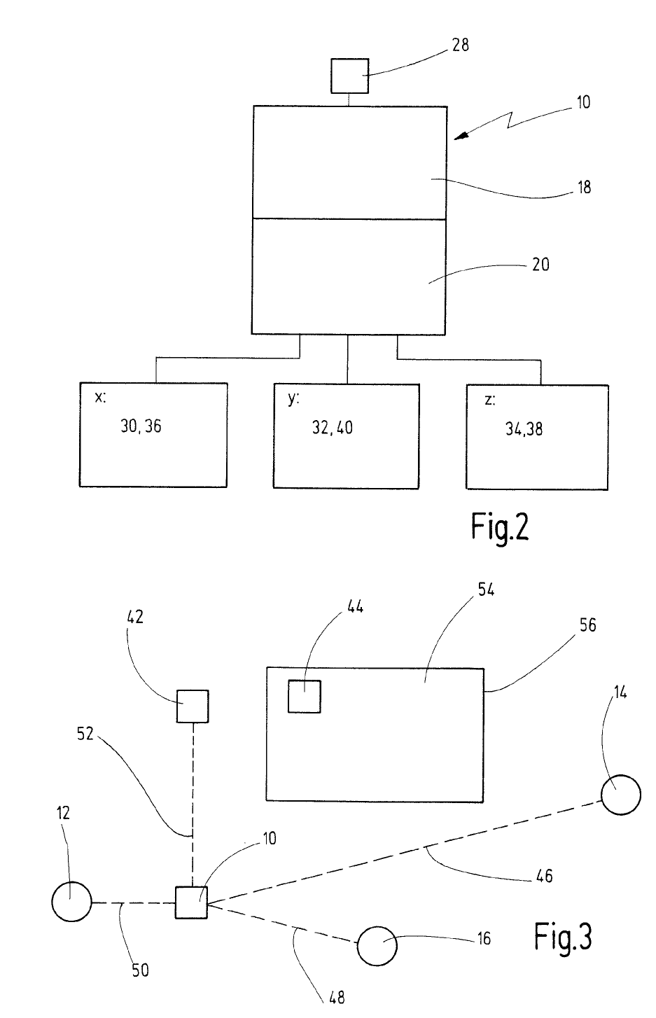

FIG. 2 shows a diagrammatic representation of a tool 10 using such a system for determining the relative position, which takes the form of an inertial module 12 coupled to a radio module 18. An antenna 28 is coupled to the radio module 18. Using the three acceleration sensors (inertial sensors) 30, 32, 34 and the three angle rate sensors 36, 38, 40 the inertial module 20 allows precise tracking of the position and orientation of the tool relative to the x axis, y axis and z axis, starting from a known reference position.

FIG. 3 illustrates by way a diagrammatic representation the interaction between the first free-field position finding system and the second relative position finding system.

A first tool 10 is connected via its radio module with three stationary base stations 12, 14, 16 through direct communication links 46, 48, 50.

It is possible in this case to accurately determine the absolute position of the tool 10 by propagation time measurement.

The system comprises a second tool 42 and a third tool 44. The tool 42 is in direct radio contact with the base stations 12 and 16, but its line of sight to the base station 14 is obstructed by the workpiece 54 (the area of radio interception is indicated by reference numeral 56 in FIG. 3).

Because of the missing connection to the second base station 14, the tool 42 is connected with the tool 10 by a communication link 52.

For determining the absolute position of the tool 42, the tool 10 is used as a further (dynamic) base station, the position of the tool 10 being known absolutely. Thus, the tool 10 serves as a third reference point for the tool 42.

The third tool 44 is located inside the workpiece 54 which latter may consist, for example, of a bodyshell on which screwing operations are to be carried out at different points. Given the fact that no radio communication exists between the tool 44 and the base stations 12, 14, 16, no free-field position finding can be performed in the area 56 of radio interception.

In this case, the position of the tool 44 in the immediate neighborhood of the area 56, at which the tool had been positioned before, is used as reference position that serves as a basis for precisely determining the different positions inside the workpiece 54 at which the tool 44 is to be positioned in succession.

What is claimed is:

1. A method for locating a position of a tool comprising the steps of performing a free-field position finding for determining an absolute position of said tool by evaluating signals propagating along communication links established between said tool and at least three base stations having a known reference position;
determining a relative position of said tool by tracking a movement of said tool relative to a known reference position; and
combining the free-field position finding step with the relative position finding step for determining the position of said tool;
wherein said step of evaluating signals comprises at least one method selected from the group formed by triangulation and propagation time measurements.

2. The method of claim 1, wherein the step of evaluating signals comprises evaluating signals selected from the group formed by ultrasound signals, optical signals, radio signals, and GPS signals;

3. The method of claim 1, wherein an absolute position determined by free-field position finding is used as a reference position for relative position finding.

4. The method of claim 3, wherein an absolute position of said tool determined by free-field position finding is taken as an intermediate reference point and is compared with a position of said tool determined by relative position finding.

5. The method of claim 1, further comprising the step of establishing a communication link between said tool and at least three base stations.

6. The method of claim 1, wherein a position of a plurality of tools is monitored by free-field position finding using direct communication with a plurality of base stations, and wherein at least one tool not being in direct communication with any of said base stations communicates with another one of said tools using positional information of a known position of said other one of said tools being in direct communication for deriving an absolute position of said at least one tool.

7. The method of claim 1, wherein said relative position finding step comprises an inertia-based method comprising evaluating signals received from at least one sensor provided on said tool, said sensor being selected from the group formed by an inertial sensor and an angle rate sensor.

8. A method for locating a position of a tool comprising the steps of performing a free-field position finding for determining an absolute position of said tool by evaluating energy propagating between said tool and at least two base stations having a known position;
determining a relative position of said tool by tracking a movement of said tool relative to a known reference position; and
combining the free-field position finding step with the relative position finding step for determining the position of said tool.

9. The method of claim 8, further comprising the step of establishing a communication link between said tool and said at least two base stations.

10. The method of claim 8, wherein the step of evaluating energy comprises evaluating signals selected from the group formed by ultrasound signals, optical signals, radio signals, and GPS signals;

11. The method of claim 8, wherein the step of evaluating energy comprises at least one method selected from the group formed by triangulation and propagation time measurements.

12. The method of claim 8, wherein an absolute position determined by free-field position finding is used as a reference position for relative position finding.

13. The method of claim 12, wherein an absolute position of said tool determined by free-field position finding is taken as an intermediate reference point and is compared with a position of said tool determined by relative position finding.

14. The method of claim 8, further comprising the step of establishing a communication link between said tool and at least three base stations.

15. The method of claim 9, wherein the step of evaluating signals propagating between said tool and said at least two base stations comprises evaluating the propagation time of said signals between said tool and said base stations for determining the absolute position of said tool.

16. The method of claim 8, wherein a position of a plurality of tools is monitored by free-field position finding using direct communication with a plurality of base stations, and wherein at least one tool not being in direct communication with any of said base stations communicates with another one of said tools using positional information of a known position of said other one of said tools being in direct communication for deriving an absolute position of said at least one tool.

17. The method of claim 8, wherein said relative position finding step comprises an inertia-based method comprising evaluating signals received from at least one sensor provided on said tool, said sensor being selected from the group formed by an inertial sensor and an angle rate sensor.

18. The method of claim 5, wherein said relative position finding step comprises an inertia-based method comprising evaluating signals received from at least one sensor provided on said tool, said sensor being selected from the group formed by an inertial sensor and an angle rate sensor.

19. The method of claim 18, wherein a position of a plurality of tools is monitored by free-field position finding using direct communication with a plurality of base stations, and wherein at least one tool not being in direct communication with any of said base stations communicates with another one of said tools using positional information of a known position of said other one of said tools being in direct communication for deriving an absolute position of said at least one tool.

20. A position finding system for locating a position of a tool, comprising a first free-field position finding system for determining an absolute position of said tool and a second relative position finding system for determining a relative position of said tool by tracking a movement of said tool relative to a known reference position, said first and second systems being coupled one with the other for locating said tool.
